(19) United States
(12) Patent Application Publication
(10) Pub. No.: US 2007/0073974 A1
(43) Pub. Date: Mar. 29, 2007

(54) Eviction algorithm for inclusive lower level cache based upon state of higher level cache

(75) Inventors: Duane Arlyn Averill, Rochester, MN (US); Brian T. Vanderpool, Byron, MN (US)

Correspondence Address: WOOD, HERRON & EVANS, L.L.P. (IBM), 2700 CAREW TOWER, 441 VINE STREET, CINCINNATI, OH, 45202, US

(73) Assignee: International Business Machines Corporation, Armonk, NY (US)

(21) Appl. No.: 11/239,616

(22) Filed: Sep. 29, 2005

(51) Int. Cl. G06F 12/00

(52) U.S. Cl. 711/133

(57) ABSTRACT

A cache eviction algorithm for an inclusive cache determines which among a plurality of cache lines may be evicted from the inclusive cache based at least in part upon the state of the cache lines in a higher level cache. In particular, a cache eviction algorithm may determine, from an inclusive cache directory for a lower level cache, whether a cache line is cached in the lower level cache but not cached in any of a plurality of higher level caches for which cache directory information is additionally stored in the cache directory. Then, based upon determining that a cache line is cached in the lower level cache but not cached in any of the plurality of higher level caches, the cache eviction algorithm may select that cache line for eviction from the cache.

### FIELD OF THE INVENTION

The invention relates to computers and data processing systems, and in particular to eviction algorithms for caches utilized in such computers and data processing systems.

### BACKGROUND OF THE INVENTION

Computer technology continues to advance at a remarkable pace, with numerous improvements being made to the performance of both processors—the“brains” of a computer—and the memory that stores the information processed by a computer.

In general, a processor operates by executing a sequence of instructions that form a computer program. The instructions are typically stored in a memory system having a plurality of storage locations identified by unique memory addresses. The memory addresses collectively define a“memory address space,” representing the addressable range of memory addresses that can be accessed by a processor.

Both the instructions forming a computer program and the data operated upon by those instructions are often stored in a memory system and retrieved as necessary by the processor when executing the computer program. The speed of processors, however, has increased relative to that of memory devices to the extent that retrieving instructions and data from a memory can often become a significant bottleneck on performance. To decrease this bottleneck, it is desirable to use the fastest available memory devices possible, e.g., static random access memory (SRAM) devices or the like. However, both memory speed and memory capacity are typically directly related to cost, and as a result, many computer designs must balance memory speed and capacity with cost.

A predominant manner of obtaining such a balance is to use multiple“levels” of memories in a memory system to attempt to decrease costs with minimal impact on system performance. Often, a computer relies on a relatively large, slow and inexpensive mass storage system such as a hard disk drive or other external storage device, an intermediate main memory that uses dynamic random access memory devices (DRAM's) or other volatile memory storage devices, and one or more high speed, limited capacity cache memories, or caches, implemented with SRAM's or the like. One or more memory controllers are then used to swap the information from segments of memory addresses, often known as“cache lines”, between the various memory levels to attempt to maximize the frequency that requested memory addresses are stored in the fastest cache memory accessible by the processor. Whenever a memory access request attempts to access a memory address that is not cached in a cache memory, a“cache miss” occurs. As a result of a cache miss, the cache line for a memory address typically must be retrieved from a relatively slow, lower level of memory, often with a significant performance hit.

One type of multi-level memory architecture that has been developed is referred to as a Non-Uniform Memory Access (NUMA) architecture, whereby multiple main memories are essentially distributed across a computer and physically grouped with sets of processors and caches into physical subsystems or modules, also referred to herein as “nodes”. The processors, caches and memory in each node of a NUMA computer are typically mounted to the same circuit board or card to provide relatively high speed interaction between all of the components that are“local” to a node. Often, a“chipset” including one or more integrated circuit chips, is used to manage data communications between the processors and the various components in the memory architecture. The nodes are also coupled to one another over a network such as a system bus or a collection of point-to-point interconnects, thereby permitting processors in one node to access data stored in another node, thus effectively extending the overall capacity of the computer. In addition, one or more levels of caches are utilized in the processors as well as in each chipset. Memory access is referred to as“non-uniform” as the access time for data stored in a local memory (i.e., a memory resident in the same node as a processor) is often significantly shorter than for data stored in a remote memory (i.e., a memory resident in another node).

A typical cache utilizes a cache directory that maps cache lines into one of a plurality of sets, where each set includes a cache directory entry and the cache line referred to thereby. In addition, a tag stored in the cache directory entry for a set is used to determine whether there is a cache hit or miss for that set—that is, to verify whether the cache line in the set to which a particular memory address is mapped contains the information corresponding to that memory address.

Often each directory entry in a cache also includes state information that indicates the state of the cache line referred to by the entry, and that is used in connection with maintaining coherency among different memories in the memory architecture. One common coherence protocol is referred to as the MESI coherence protocol, which tags each entry in a cache in one of four states: Modified, Exclusive, Shared, or Invalid. The Modified state indicates that the entry contains a valid cache line, and that the entry has the most recent copy thereof—i.e., all other copies, if any, are no longer valid. The Exclusive state is similar to the Modified state, but indicates that the cache line in the entry has not yet been modified. The Shared state indicates that a valid copy of a cache line is stored in the entry, but that other valid copies of the cache line may also exist in other devices. The Invalid state indicates that no valid cache line is stored in the entry.

Caches may also have different degrees of associativity, and are often referred to as being N-way set associative. Each“way” or class represents a separate directory entry and cache line for a given set in the cache directory. Therefore, in a one-way set associative cache, each memory address is mapped to one directory entry and one cache line in the cache. Multi-way set associative caches, e.g., four-way set associative caches, provide multiple directory entries and cache lines to which a particular memory address may be mapped, thereby decreasing the potential for performance-limiting hot spots that are more commonly encountered with one-way set associative caches.

In addition, some caches may be“inclusive” in nature, as these caches maintain redundant copies of any cache lines that are cached by any higher level caches to which such caches are coupled. While an inclusive cache has a lower effective capacity than an “exclusive” cache due to the storage of redundant copies of cache lines that are cached in higher level caches, an inclusive cache provides a performance benefit in that the status of a cache line that is cached by any higher level cache coupled to an inclusive cache can be determined simply through a check of the status of the cache line in the inclusive cache.

One potential operation of a cache that may have an impact on system performance is that of cache line eviction. Any cache, being of limited size, is frequently required to cast out, or evict, a cache line from the cache whenever space for a new cache line is needed. In the case of a one-way set associative cache, the eviction of a cache line is unexceptional, as each cache line is mapped to a single entry in a cache, so an incoming cache line will necessarily replace any existing cache line that is stored in the single entry to which the incoming cache line is mapped.

On the other hand, in a multi-way set associative cache, an incoming cache line may potentially be stored in one of multiple entries mapped to the same set. It has been found that the selection of which entry to store the incoming cache line in, which often necessitates the eviction of a cache line previously stored in the selected entry, can have a significant impact on system performance. As a result, various selection algorithms, often referred to as eviction algorithms, have been developed to attempt to minimize the impact of cache line evictions on system performance.

Many conventional eviction algorithms select an empty entry in a set (e.g., an entry with an Invalid MESI state) if possible. However, where no empty entry exists, various algorithms may be used, including selecting the Least Recently Used (LRU) entry, selecting the Most Recently Used (MRU) entry, selecting randomly, selecting in a round robin fashion and variations thereof. Often, different algorithms work better in different environments.

One drawback associated with some conventional eviction algorithms such as LRU and MRU-based algorithms is that such algorithms are required to track the accesses to various entries in a set to determine which entry has been most recently or least recently used. In some caches, however, it may not be possible to determine a cache line's actual reference pattern. In particular, inclusive caches typically are not provided with the reference patterns for cache lines that are also cached in higher level caches.

As an example, in one implementation of the aforementioned NUMA memory architecture, each node in the architecture may include multiple processors coupled to a node controller chipset by one or more processor buses, with each processor having one or more dedicated cache memories that are accessible only by that processor, e.g., level one (L1) data and/or instruction caches, a level two (L2) cache and a level three (L3) cache. An additional level four (L4) cache may be implemented in the node controller itself and shared by all of the processors.

Where the L4 cache is implemented as an inclusive cache, the L4 cache typically does not have full visibility to a given cache line's actual reference pattern. In particular, an external L4 cache, being coupled to each processor over a processor bus, typically can only determine when a cache line is accessed whenever the L4 cache detects the access on the processor bus. However, a cache line that is frequently used by the same processor may never result in any operations being performed on the processor bus after the cache line is initially loaded into a dedicated cache for that processor. As a result, any cache eviction algorithm in the L4 cache that relies on tracked accesses to cache lines may make incorrect assumptions about the reference patterns for such cache lines, and thus select the wrong cache line to evict.

Therefore, a significant need exists in the art for an improved eviction algorithm for use with inclusive caches.

### SUMMARY OF THE INVENTION

The invention addresses these and other problems associated with the prior art by utilizing a state-based cache eviction algorithm for an inclusive cache that determines which among a plurality of cache lines may be evicted from the inclusive cache based at least in part upon the state of the cache lines in a higher level cache. In particular, a cache eviction algorithm consistent with the invention determines, from an inclusive cache directory for a lower level cache whether a cache line is cached in the lower level cache but not cached in any of a plurality of higher level caches for which cache directory information is additionally stored in the cache directory, and evicts the cache line from the lower level cache based upon determining that the cache line is cached in the lower level cache but not cached in any of the plurality of higher level caches.

These and other advantages and features, which characterize the invention, are set forth in the claims annexed hereto and forming a further part hereof. However, for a better understanding of the invention, and of the advantages and objectives attained through its use, reference should be made to the Drawings, and to the accompanying descriptive matter, in which there is described exemplary embodiments of the invention.

### BRIEF DESCRIPTION OF THE DRAWINGS

FIG. 1 is a block diagram of a multinode computer system suitable for utilizing a state-based cache eviction algorithm consistent with the invention.

FIG. 2 is a block diagram of the cache architecture for one of the nodes from the multinode computer system of FIG. 1;

FIG. 3 is a flowchart illustrating a cache line fill request processing routine implementing a state-based cache eviction algorithm in the L4 cache in the cache architecture of FIG. 2.

FIG. 4 is a block diagram of an exemplary state of a set of cache lines stored in the cache architecture of FIG. 2.

FIG. 5 is a block diagram illustrating a state change from that of FIG. 4 as a result of a cache line request that hits the L4 cache.

FIG. 6 is a block diagram illustrating a state change from that of FIG. 5 as a result of a cache line request that misses the L4 cache when an empty entry is available in the associativity set for the requested cache line in the L4 cache.

FIG. 7 is a block diagram illustrating a state change from that of FIG. 6 as a result of a cache line request that misses the L4 cache when an entry is available in the associativity set for the requested cache line in the L4 cache corresponding to a cache line that is cached in the L4 cache but not cached in any higher level cache.

FIG. 8 is a block diagram illustrating a state change from that of FIG. 7 as a result of a cache line request that misses the L4 cache when no entry is available in the associativity set for the requested cache line in the L4 cache corresponding to a cache line that is cached in the L4 cache but not cached in any higher level cache.

FIG. 9 is a block diagram illustrating a state change from that of FIG. 8 as a result of a cache line request that misses the L4 cache when multiple entries are available in the associativity set for the requested cache line in the L4 cache corresponding to cache lines that are cached in the L4 cache but not cached in any higher level cache.

### DETAILED DESCRIPTION

The embodiments discussed and illustrated hereinafter implement a state-based cache eviction algorithm for an inclusive cache that is based at least in part upon the state of cache lines in a higher level cache. Specifically, cache eviction algorithms consistent with the invention attempt to identify cache lines that are cached in an inclusive cache, but not cached in any higher level caches coupled thereto. As a result, cache lines that are no longer present in higher level caches, and presumably not being used by any of the processors served by such caches, will be selected for eviction over cache lines that are still cached in a higher level cache, and thus presumably still being used by a processor. By doing so, the likelihood of a processor needing to access the evicted cache line in the immediate future is reduced, thus minimizing the likelihood of a cache miss and the consequent impact on performance.

In addition, in many implementations additional performance gains are realized due to minimizing the overhead associated with notifying higher level caches to invalidate their copies of evicted cache lines, since evicted cache lines that are not cached in any higher level cache do not require that any higher level cache be notified of the eviction of such cache lines. Particularly in environments where an inclusive cache is coupled to higher level caches via a bandwidth limited interface such as a processor bus, the elimination of such back-invalidate traffic reduces processor bus utilization and frees bandwidth for use in other operations. In addition, in pipelined processor architectures, eliminating the back-invalidate traffic can also minimize internal processor pipeline disruptions resulting from such traffic.

A cache eviction algorithm consistent with the invention typically determines, from an inclusive cache directory for a lower level cache whether a cache line is cached in the lower level cache but not cached in any of a plurality of higher level caches for which cache directory information is additionally stored in the cache directory. As will be discussed in greater detail below, the determination may be based upon state information maintained in the lower level cache directory that indicates whether a cache line is cached in a higher level cache. Such state information may be combined with state information for the cache line in the lower level cache, or may be separately maintained. Moreover, the state information may indicate which higher level cache has a valid copy of a cache line, or the state information may simply indicate that some higher level cache that is coupled to the lower level cache has a valid copy of the cache line without identifying which higher level cache has the valid copy. The state information for multiple higher level caches may be grouped together, e.g., by processor or by processor bus, or the state information for each cache may be separately maintained. The state information may also identify the actual state of a cache line in a higher level cache, or alternatively may only indicate that a higher level cache has a copy of the cache line in a non-invalid state. As an example, a cache directory for a lower level cache may require only a single bit that indicates whether or not a valid copy of an associated cache line is cached in a higher level cache. It will be appreciated, however, that in other embodiments additional state information may be stored in a lower level cache directory.

As will also become more apparent below, the eviction of a cache line based upon the state of the cache line in a higher level directory may be incorporated into various known eviction algorithms consistent with the invention. For example, as described in more detail below, it may be desirable in a multi-way set associative inclusive cache to implement an eviction algorithm that first selects an empty entry in an associativity set, then selects an entry for a cache line that is cached in the inclusive cache but not cached in any higher level cache if no empty entry exists, and finally selects an entry via an MRU, LRU, random, round robin, or other conventional algorithm if no cache line is found that is cached in the inclusive cache but not in any higher level cache. In addition, it may be desirable in some embodiments to apply MRU, LRU, random, round robin, or other techniques in connection with a determination that multiple entries in an associativity set have cache lines that are not cached in a higher level cache.

It will be appreciated that a cache is a“higher level cache” relative to an inclusive lower level cache whenever the lower level cache is coupled intermediate the higher level cache and the main memory of the computer. In the illustrated embodiment below, for example, the lower level cache is an L4 cache in the node controller of a multi-node computer, while the higher level caches are the L1, L2 and L3 caches disposed within the processors that are coupled to the node controller. It will be appreciated that a higher level cache and a lower level cache may be directly coupled to one another, or may be coupled to one another via an intermediate memory or cache. In addition, higher level caches may be dedicated to specific processors, or may be shared by multiple processors. Furthermore, a higher level cache may be multi-way set associative or one-way set associative, may itself be inclusive or exclusive, and may be only a data or instruction cache. Other variations will be apparent to one of ordinary skill in the art having the benefit of the instant disclosure.

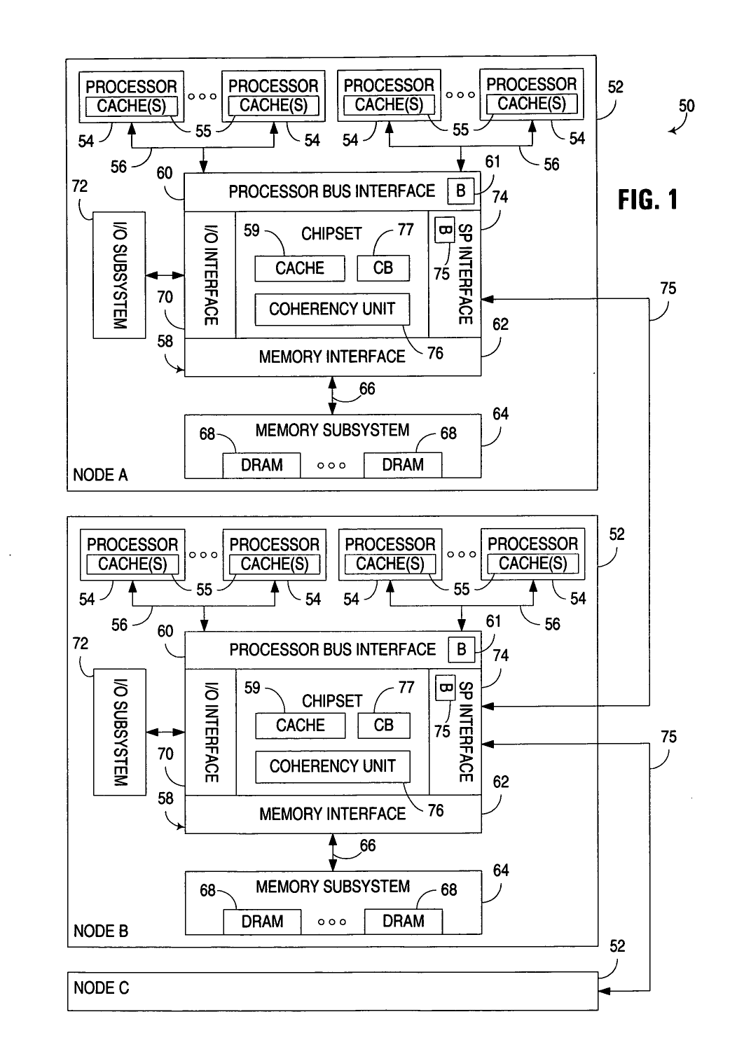

Now turning to the Drawings, wherein like numbers denote like parts throughout the several views, FIG. 1 illustrates a multinode computer 50 that represents one suitable environment within which the herein-described state-based cache eviction algorithm may be implemented in a manner consistent with the invention. Computer 50 generically represents, for example, any of a number of multi-user computers such as a network server, a midrange computer, a mainframe computer, etc. However, it should be appreciated that the invention may be implemented in practically any device capable of utilizing a shared memory architecture including multiple cache levels, including other computers and data processing systems, e.g., in single-user computers such as workstations, desktop computers, portable computers, and the like, or in other programmable electronic devices (e.g., incorporating embedded controllers and the like), such as set top boxes, game machines, etc.

Computer 50, being implemented as a multinode computer, includes a plurality of nodes 52, each of which generally including one or more processors 54, each including one or more caches 55, and coupled to one or more system or processor buses 56. Also coupled to each of processor buses 24 is a chipset 58 incorporating a chipset cache 59, a processor bus interface 60, and a memory interface 62, which connects to a memory subsystem 64 over a memory bus 66. Memory subsystem typically includes a plurality of memory devices, e.g., DRAM's 68, which provides the main memory for each node 52.

For connectivity with peripheral and other external devices, chipset 58 also includes an input/output interface 70 providing connectivity to an I/O subsystem 72. Furthermore, to provide internodal connectivity, an internodal interface, e.g., a scalability port interface 74, is provided in each node to couple via a communications link 75 to one or more other nodes 52. Chipset 58 also typically includes a number of buffers resident therein, e.g., a central buffer 77, as well as one or more dedicated buffers 61, 75 respectively disposed in processor bus interface 60 and scalability port interface 74. Chipset 58 also includes control logic referred to herein as a coherency unit 76 to manage the processing of memory requests provided to the chipset by processors 54 and/or remote nodes 52 over a scalability port interconnect 75.

It will be appreciated that multiple ports or interfaces of any given type may be supported in chipset 58. As shown in FIG. 1, for example, it may be desirable to support multiple processor buses (or bus segments) in each node, which may result in the need to source data requested by a processor on one processor bus by communicating the data from a processor on another processor bus. Furthermore, the various interfaces supported by chipset 58 may implement any number of known protocols. For example, chipset 58 may be compatible with the processor bus protocol for the Xeon line of processors from Intel Corporation. It will be appreciated however that the principles of the invention apply to other computer implementations, including other multinode designs, single node designs, and other designs utilizing multi-level memory systems.

Chipset 58 may be implemented using one or more integrated circuit devices, and may be used to interface with additional electronic components, e.g., graphics controllers, sound cards, firmware, service processors, etc. It should therefore be appreciated that the term chipset may describe a single integrated circuit chip that implements the functionality described herein, and may even be integrated in whole or in part into another electronic component such as a processor chip.

Computer 50, or any subset of components therein, may be referred to hereinafter as an“apparatus”. It should be recognized that the term“apparatus” may be considered to incorporate various data processing systems such as computers and other electronic devices, as well as various components within such systems, including individual integrated circuit devices or combinations thereof. Moreover, within an apparatus may be incorporated one or more logic circuits that circuit arrangements, typically implemented on one or more integrated circuit devices, and optionally including additional discrete components interfaced therewith.

It should also be recognized that circuit arrangements are typically designed and fabricated at least in part using one or more computer data files, referred to herein as hardware definition programs, that define the layout of the circuit arrangements on integrated circuit devices. The programs are typically generated in a known manner by a design tool and are subsequently used during manufacturing to create the layout masks that define the circuit arrangements applied to a semiconductor wafer. Typically, the programs are provided in a predefined format using a hardware definition language (HDL) such as VHDL, Verilog, EDIF, etc. Thus, while the invention has and hereinafter will be described in the context of circuit arrangements implemented in fully functioning integrated circuit devices, those skilled in the art will appreciate that circuit arrangements consistent with the invention are capable of being distributed as program products in a variety of forms, and that the invention applies equally regardless of the particular type of computer readable media used to actually carry out the distribution. Examples of computer readable media include but are not limited to tangible, recordable type media such as volatile and non-volatile memory devices, floppy disks, hard disk drives, CD-ROM's, and DVD's, among others, and transmission type media such as digital and analog communications links.

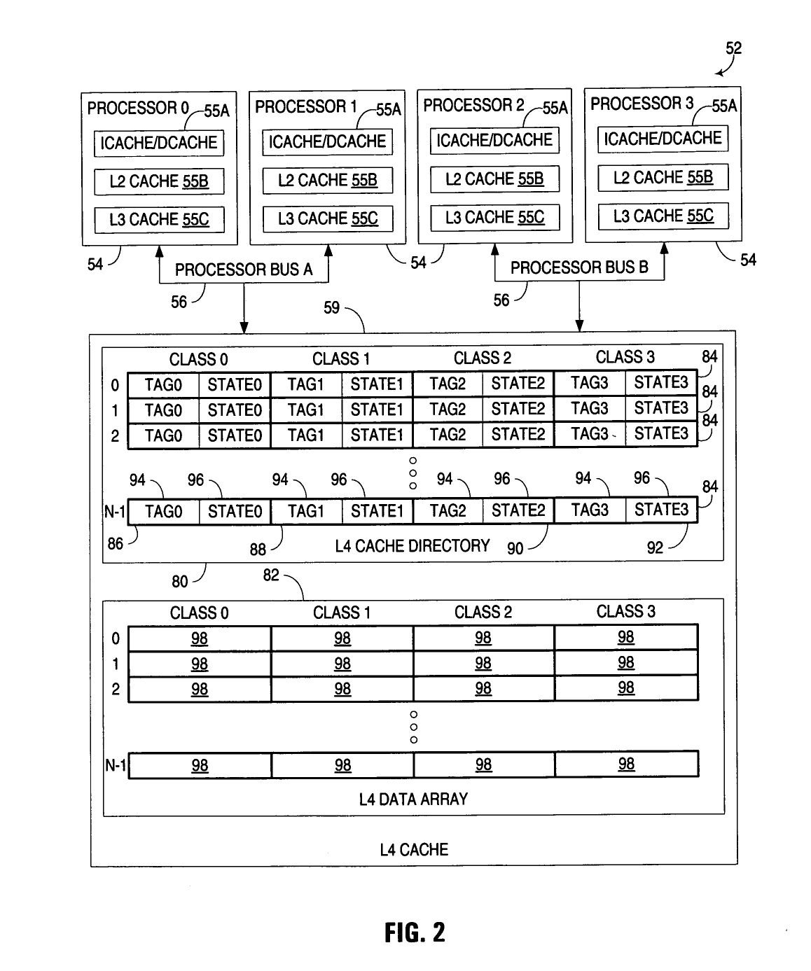

FIG. 2 illustrates an exemplary cache architecture for one of the nodes 52 in computer 50. In this architecture, four processor chips 54, also denoted as processors 0-3, are coupled to the chipset via a pair of processor buses 56, also denoted as processor buses A and B. Processors 0 and 1 are coupled to processor bus A, while processors 2 and 3 are coupled to processor bus B.

In addition, in this exemplary architecture, four levels of caches are provided, with L1, L2, and L3 caches 55A, 55B, and 55C being provided on each processor chip 54, and with the chipset cache 59 being implemented as an L4 cache. L1 cache 55A is implemented as separate instruction and data caches, while L2 and L3 caches 55B and 55C cache both instructions and data.

L4 cache 59 includes a cache directory 80 and a data array 82, which may or may not be disposed on the same integrated circuit. L4 cache 59 is implemented as an inclusive 4-way set associative cache including N associativity sets 0 to N-1, with each associativity set 84 in directory 80 including four entries 86, 88, 90 and 92 respectively associated with four associativity classes 0, 1, 2 and 3. Each entry 86-92 in directory 80 includes a tag field 94, which stores the tag of a currently cached cache line, and a state field 96 that stores the state of a currently cached cache line, e.g., using the MESI protocol or another state protocol known in the art. Each entry 86-92 has an associated slot 98 in data array 82 where the data for each cached cache line is stored.

The state field 96 in each entry 86-92 stores state information for both the L1 cache and for the higher level L1-L3 caches 55A, 55B and 55C. In the illustrated embodiment, state information for the higher level caches is based upon a processor bus by processor bus basis, and moreover, the state information for each processor bus, as well as for the L4 cache, is encoded into a single field. For example, in one embodiment consistent with the invention, the state information for the L4 cache, the processor bus A (PBA) caches, and the processor bus B (PBB) caches is encoded into a 5-bit field, as shown below in Table 1. Moreover, in the illustrated embodiment, the L4 cache is not notified by a processor whenever that processor modifies its copy of a cache line, so the L4 cache does not distinguish between Exclusive and Modified states for the each processor bus. In other embodiments, a processor may notify the L4 cache of a state change from Exclusive to Modified such that the L4 cache will update the appropriate PBA or PBB state for the cache line.

TABLE I
Example State Encoding

| Encode | L4 State | PBA State | PBB State |
|---|---|---|---|
| b10000 | I | I | I |
| b00000 | S | I | I |
| b00001 | S | S | I |
| b00010 | S | I | S |
| b00011 | S | S | S |
| b00100 | E | I | I |
| b00101 | E | S | I |
| b00110 | E | I | S |
| b00111 | E | S | S |
| b01000 | E | E | I |
| b01001 | E | I | E |
| b01010 | M | I | I |
| b01011 | M | S | I |
| b01100 | M | I | S |
| b01101 | M | S | S |
| b01110 | M | E | I |
| b01111 | M | I | E |

It will be appreciated by one of ordinary skill in the art that other state protocols may be used, as may other mappings or encodings. Furthermore, state information may be partitioned on a processor-by-processor basis, or the state information may simply indicate whether any processor has a valid copy of a cache line. Other variations of storing state information that indicates whether a higher level cache has a valid copy of a cache line will be appreciated by one of ordinary skill in the art having the benefit of the instant disclosure.

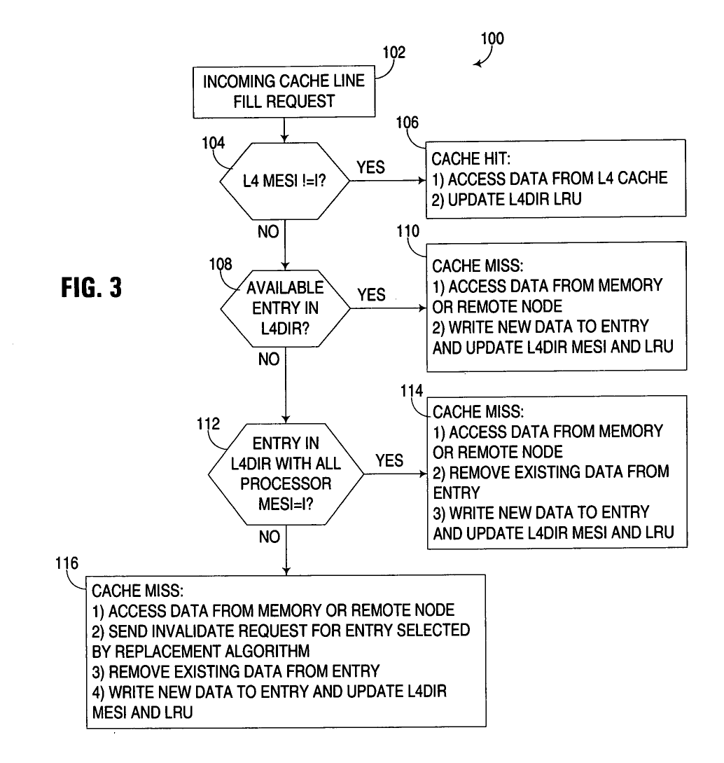

FIG. 3 next illustrates a cache line fill request processing routine 100 that implements a state-based cache eviction algorithm in the control logic of an L4 cache 59 of computer 50. Block 102, in particular, illustrates the receipt of an incoming cache line fill request from one of the processors 54 coupled to chipset 58. Block 104 next determines whether the requested cache line is in the L4 cache and the L4 MESI state is any state other than invalid (i.e., a cache hit). If so, control passes to block 106 to handle the request by accessing the data from the L4 cache and returning the data to the requesting processor. In addition, in this exemplary embodiment, it is assumed that the cache implements an LRU algorithm in situations where no entry is found in the associativity set for the cache line that is either unused, or if all entries are currently in use, no entry is found in the associativity set that is cached in the L4 cache but not in any higher level cache. As such, block 106 also updates the LRU information stored in the L4 cache directory. Processing of the cache line request is then complete.

Returning to block 104, if no cache hit occurs, the data must be fetched from an alternate source (e.g., node memory, a remote node, etc.). In addition, space for the new cache line must be allocated in the L4 cache. As such, control passes to block 106 to determine whether an available or unused entry exists in the associativity set for the requested cache line, e.g., by determining whether any entry in the associativity set has an invalid state. If so, control passes to block 108 to access the requested data from the node memory or a remote node (as appropriate). Once the data is retrieved, the data is then written into the empty entry, along with updating the MESI state and LRU information for the entry accordingly. Processing of the cache line request is then complete.

Returning to block 108, if no available entry is found, control passes to block 112 to determine whether any entry in the associativity set for the requested cache line is associated with a cache line that is not currently cached in any higher level cache, e.g., by determining whether any entry has an invalid state for all processor buses. If so, control passes to block 114 to access the requested data from the node memory or a remote node (as appropriate). Once the data is retrieved, the existing data in the identified entry is removed and replaced with the retrieved data, along with updating the MESI state and LRU information for the entry accordingly. Processing of the cache line request is then complete.

Returning to block 112, if no entry is found to be associated with a cache line that is not cached in a higher level cache, control passes to block 116 to select an entry according to a replacement algorithm, e.g., the aforementioned LRU algorithm. As such, block 116 accesses the requested data from the node memory or a remote node (as appropriate) and selects an entry according to the replacement algorithm, e.g., the least recently used entry. In addition, an invalidate request is sent to the relevant processor bus or buses for the cache line associated with the selected entry, and the existing data in the selected entry is removed and replaced with the retrieved data, along with updating the MESI state and LRU information for the entry accordingly. Processing of the cache line request is then complete.

It will be appreciated that other logic may be implemented in routine 100 in the alternative. For example, in the event of finding multiple available entries in block 108 or multiple entries associated with cache lines that are not cached in higher level caches in block 112, a replacement algorithm that is the same or different from that used in block 116 may be used to select from among the multiple entries.

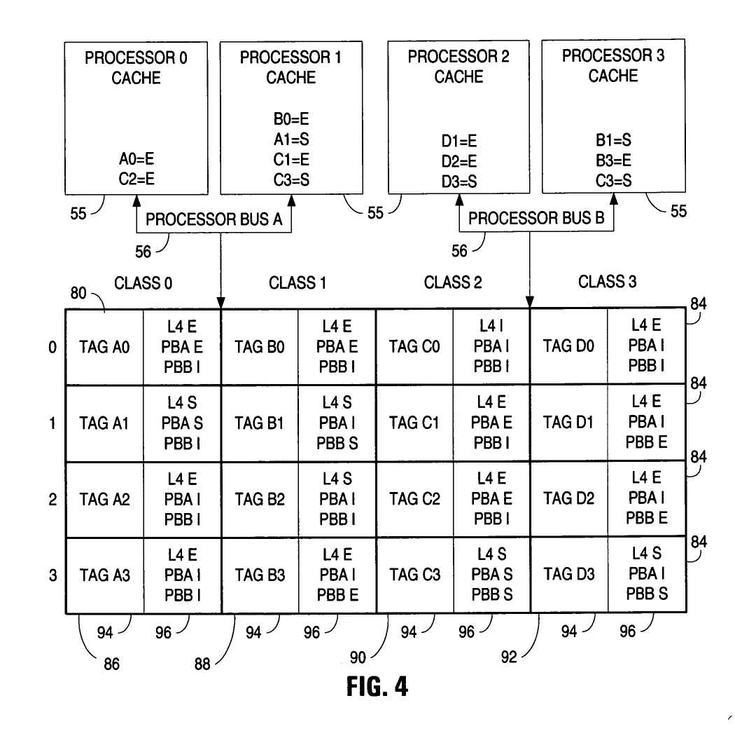

FIGS. 4-9 provide a further illustration of the operation of the state-based cache eviction algorithm implemented in computer 50 by illustrating the result of handling a series of cache line requests via the logic implemented in routine 100. FIG. 4, in particular, illustrates a set of four associativity sets 84 stored in L4 cache directory 80, with exemplary tag and state information 94, 96 stored in each associativity class entry 86, 88, 90 and 92. It is assumed in FIG. 4 that cache lines identified as A0-A3, B0-B3, C0-C3 and D0-D3 are stored in the cache, with associated tag information in each entry 86-92 identifying the relevant cache line, and with the MESI state information for each entry identifying the state of the cache line in each of the L4 cache, the processor bus A processors, and the processor bus B processors. Of note, cache line C0, in class 2 of associativity set 0, is shown as being invalidated, but the remainder of the entries are shown with valid cache lines. FIG. 4 also illustrates the local MESI state of each cache line in the associated higher level caches 55.

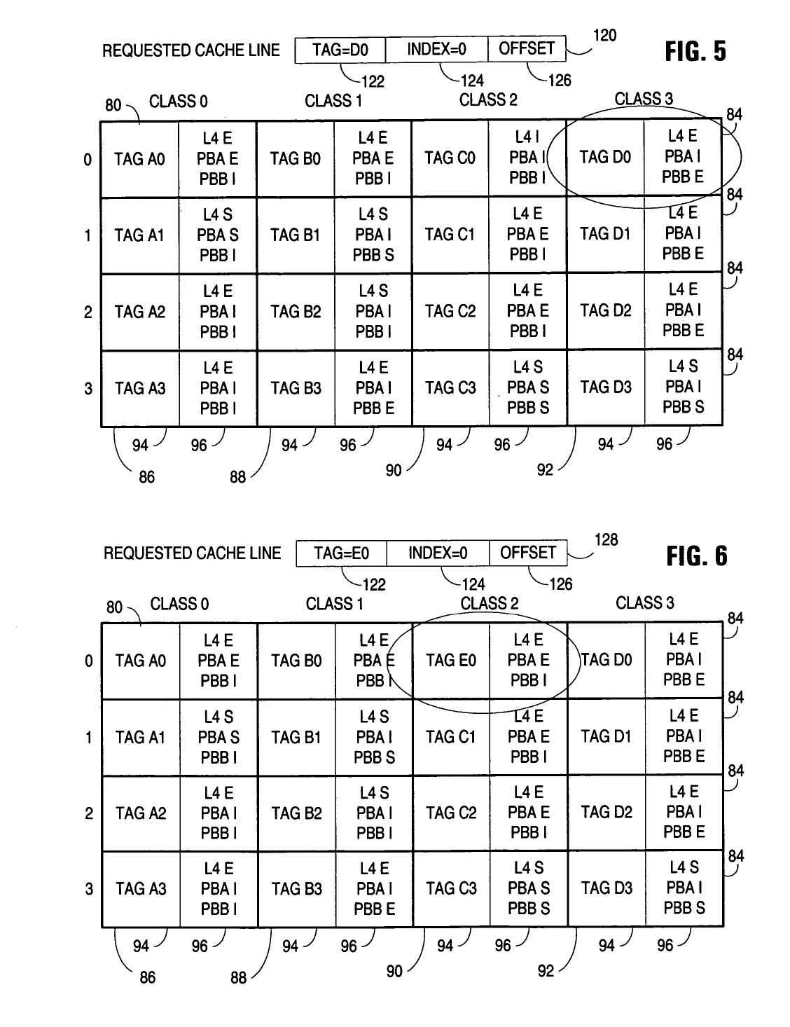

FIG. 5 illustrates the processing of a cache line request for an address 120 from a processor on processor bus B, having a tag portion 122 identifying cache line D0, an index portion identifying associativity set 0 and an offset portion 126 representing the offset of the address in the requested cache line. Of note, since address 120 is cached along with cache line D0 in class 3 of associativity set 0, routine 100 (FIG. 3) will detect a cache hit in block 104 and handle the request as described above in connection with block 106, returning the requested cache line to the requesting processor over processor bus B and updating the state information for cache line D0 to indicate that a processor on processor bus B now has the cache line in an Exclusive state.

FIG. 6 next illustrates the processing of a cache line request for an address 128 from a processor on processor bus A, having a tag portion 122 identifying a cache line E0 and an index portion identifying associativity set 0. Of note, since cache line E0 is not currently cached (i.e., the tag information for cache line E0 does not match that of any entry 86-92 in associativity set 0), routine 100 (FIG. 3) will detect a cache miss in block 104. In addition, since one of the entries in associativity set 0 (entry 90) indicates that all states are invalid, block 108 will determine that an available entry exists and handle the request as described above in connection with block 110, returning the requested cache line to the requesting processor over processor bus A and writing the tag and state information for cache line E0 in entry 90 to indicate that a processor on processor bus A now has the cache line in an Exclusive state.

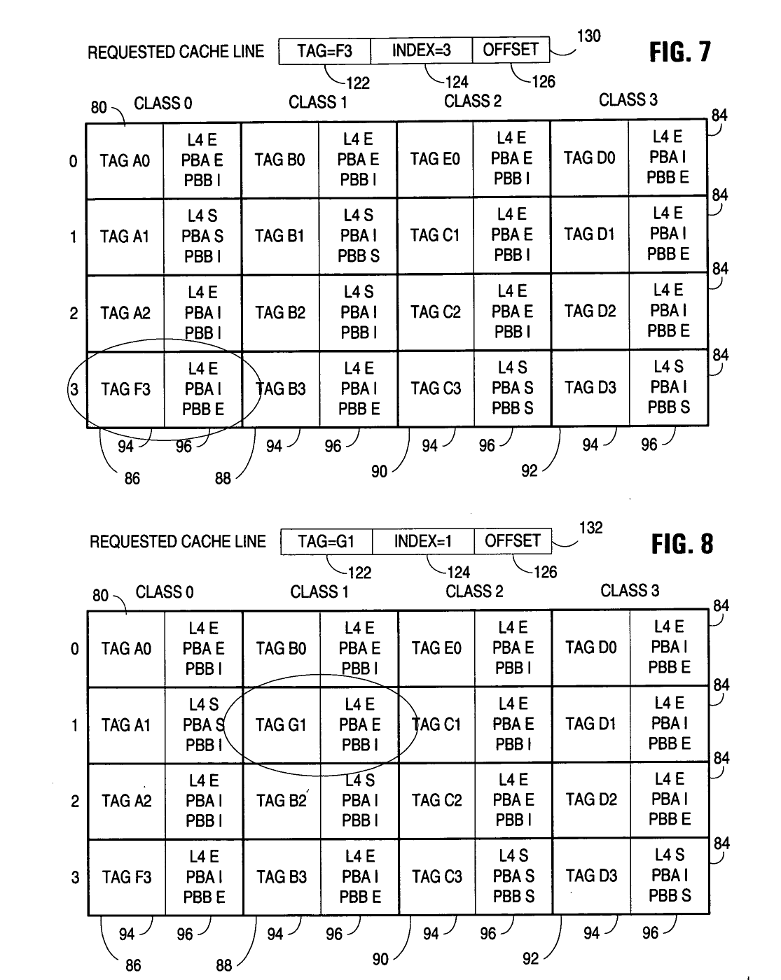

FIG. 7 next illustrates the processing of a cache line request for an address 130 from a processor on processor bus B, having a tag portion 122 identifying a cache line F 3 and an index portion identifying associativity set 3. Of note, since cache line F3 is not currently cached (i.e., the tag information for cache line F3 does not match that of any entry 86-92 in associativity set 3), routine 100 (FIG. 3) will detect a cache miss in block 104. In addition, since none of the entries in associativity set 3 indicates that all states are invalid, block 108 will determine that no available entry exists. Furthermore, since entry 86 in associativity class 0 of associativity set 3 indicates that cache line A3 is not cached in any processor (by virtue of the state for each of the processor buses being Invalid), block 112 will determine that an entry exists for a cache line that is not cached in a higher level cache, and handle the request as described above in connection with block 114, returning the requested cache line to the requesting processor over processor bus B and writing the tag and state information for cache line F3 in entry 86 to indicate that a processor on processor bus B now has the cache line in an Exclusive state. Of note, since cache line A3 was not cached in any processor, no invalidate request needs to be sent to either processor bus, as would otherwise be required were another cache line in the associativity set selected for replacement.

FIG. 8 next illustrates the processing of a cache line request for an address 132 from a processor on processor bus A, having a tag portion 122 identifying a cache line G1 and an index portion identifying associativity set 1. Of note, since cache line G1 is not currently cached (i.e., the tag information for cache line G1 does not match that of any entry 86-92 in associativity set 1), routine 100 (FIG. 3) will detect a cache miss in block 104. In addition, since none of the entries in associativity set 1 indicates that all states are invalid, block 108 will determine that no available entry exists. Furthermore, since no entry in associativity set 1 is associated with a cache line that is not cached in any processor (by virtue of the state for each entry having at least one non-invalid state for one of the processor buses), block 112 will determine that no entry exists for a cache line that is not cached in a higher level cache, and handle the request as described above in connection with block 116. Assuming, for example, that entry 88 is the least recently used entry in associativity set 1, block 116 may select that entry for replacement, returning the requested cache line to the requesting processor over processor bus A and writing the tag and state information for cache line G1 in entry 88 to indicate that a processor on processor bus A now has the cache line in an Exclusive state. In addition, block 116 will send an invalidate request over processor bus B to invalidate the copy of the cache line B1 in the cache for processor 3 (see FIG. 4).

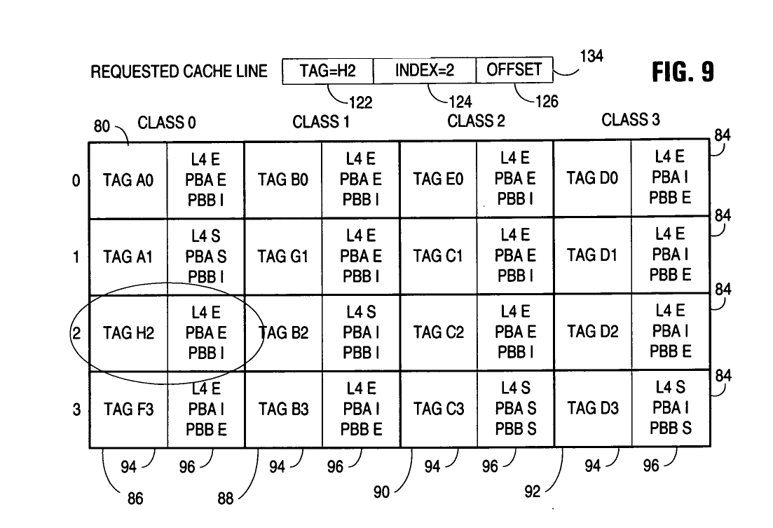

FIG. 9 next illustrates the processing of a cache line request for an address 134 from a processor on processor bus A, having a tag portion 122 identifying a cache line H2 and an index portion identifying associativity set 2. Of note, since cache line H2 is not currently cached (i.e., the tag information for cache line H2 does not match that of any entry 86-92 in associativity set 2), routine 100 (FIG. 3) will detect a cache miss in block 104. In addition, since none of the entries in associativity set 2 indicates that all states are invalid, block 108 will determine that no available entry exists. Furthermore, since both entries 86 and 88 in associativity classes 0 and 1 of associativity set 2 indicate that cache lines A2 and B2 are not cached in any processor (by virtue of the state for each of the processor buses being Invalid), block 112 will determine that an entry exists for a cache line that is not cached in a higher level cache, and handle the request as described above in connection with block 114. Furthermore, since multiple entries match the criteria, block 114 will select from among the multiple entries using a replacement algorithm, e.g., LRU, MRU, random, round robin, etc. For example, it may be desirable to simply select the lowest associativity class among the matching entries, in this case associativity class 0. Thus, in this example, block 114 will return the requested cache line to the requesting processor over processor bus A and write the tag and state information for cache line H2 in entry 86 to indicate that a processor on processor bus A now has the cache line in an Exclusive state. Of note, since cache line A2 was not cached in any processor, no invalidate request needs to be sent to either processor bus.

It will be appreciated that various modifications may be made to the illustrated embodiments consistent with the invention. It will also be appreciated that implementation of the functionality described above within logic circuitry disposed in a chipset or other appropriate integrated circuit device, would be well within the abilities of one of ordinary skill in the art having the benefit of the instant disclosure.

What is claimed is:

1. A circuit arrangement, comprising:
a plurality of processors, each processor including at least one higher level cache; and
an inclusive multi-way set associative lower level cache coupled to the plurality of processors, the lower level cache including a cache directory including cache directory information for a plurality of cache lines that are currently cached in any of the lower level cache and plurality of processors, the lower level cache configured to, in response to a cache miss on a requested cache line, selectively evict a cache line from the lower level cache based upon a determination that the cache line is cached in the lower level cache but is not cached in any of the plurality of processors.

2. A circuit arrangement, comprising:
an inclusive cache directory associated with a lower level cache and configured to store cache directory information for the lower level cache and a plurality of higher level caches; and
control logic coupled to the inclusive cache directory and configured to selectively evict a cache line from the lower level cache based upon a determination that the cache line is cached in the lower level cache but not cached in any of the plurality of higher level caches.

3. The circuit arrangement of claim 2, wherein the lower level cache is disposed in a node controller of a multi-node data processing system, and wherein the plurality of high level caches are disposed in a plurality of processors coupled to the node controller.

4. The circuit arrangement of claim 3, wherein the lower level cache is a fourth level cache, and wherein the plurality of high level caches includes at least one first, second, and third level cache disposed in each of the plurality of processors coupled to the node controller.

5. The circuit arrangement of claim 2, further comprising a cache memory for the lower level cache.

6. The circuit arrangement of claim 2, wherein the control logic is configured to selectively evict the cache line in response to a request for another cache line that misses on the lower level cache.

7. The circuit arrangement of claim 6, wherein the inclusive cache directory comprises a multi-way set associative cache directory, wherein the other cache line is in the same associativity set as the evicted cache line, and wherein the control logic is configured to selectively evict the cache line only after determining that no empty associativity class exists for the associativity set.

8. The circuit arrangement of claim 7, wherein the control logic is further configured to apply a cache replacement algorithm in response to determining that no associativity class in the associativity set stores a cache line that is cached in the lower level cache but not cached in any of the plurality of higher level caches.

9. The circuit arrangement of claim 8, wherein the cache replacement algorithm is selected from the group consisting of least recently used, most recently used, random and round robin.

10. An integrated circuit device comprising the circuit arrangement of claim 2.

11. A chipset comprising the circuit arrangement of claim 2.

12. A data processing system, comprising:
a plurality of processors; and
a node controller coupled to the plurality of processors and comprising the circuit arrangement of claim 2, wherein the plurality of higher level caches are disposed in the plurality of processors.

13. The data processing system of claim 12, wherein the plurality of processors and the node controller are disposed in a first node among a plurality of nodes in the data processing system.

14. A program product, comprising a hardware definition program that defines the circuit arrangement of claim 2; and a computer readable medium bearing the hardware definition program.

15. A method of evicting a cache line from a cache, the method comprising:
determining from an inclusive cache directory for a lower level cache whether a cache line is cached in the lower level cache but not cached in any of a plurality of higher level caches for which cache directory information is additionally stored in the cache directory; and
evicting the cache line from the lower level cache based upon determining that the cache line is cached in the lower level cache but not cached in any of the plurality of higher level caches.

16. The method of claim 15, wherein the lower level cache is disposed in a node controller of a multi-node data processing system, and wherein the plurality of high level caches are disposed in a plurality of processors coupled to the node controller.

17. The method of claim 16, wherein the lower level cache is a fourth level cache, and wherein the plurality of high level caches includes at least one first, second, and third level cache disposed in each of the plurality of processors coupled to the node controller.

18. The method of claim 15, wherein determining and evicting are performed in response to a request for another cache line that misses on the lower level cache.

19. The method of claim 18, wherein the inclusive cache directory comprises a multi-way set associative cache directory, wherein the other cache line is in the same associativity set as the evicted cache line, and wherein evicting the cache line is performed only after determining that no empty associativity class exists for the associativity set.

20. The method of claim 19, further comprising applying a cache replacement algorithm in response to determining that no associativity class in the associativity set stores a cache line that is cached in the lower level cache but not cached in any of the plurality of higher level caches.

21. The method of claim 20, wherein the cache replacement algorithm is selected from the group consisting of least recently used, most recently used, random and round robin.
